(19) United States
(12) Patent Application Publication
(10) Pub. No.: US 2016/0124779 A1
(43) Pub. Date: May 5, 2016

(54) LAUNCH CONTROL METHOD AND LAUNCH CONTROL APPARATUS

(71) Applicant: FUJITSU LIMITED, Kawasaki-shi (JP)

(72) Inventors: Keishi Imai, Suntou (JP); Mitsuaki Iwasa, Mishima (JP); Yasunori Shibata, Numazu (JP); Katsumi Matsumoto, Amagasaki (JP); Minoru Yamanaka, Fuji (JP); Masafumi Eguchi, Numazu (JP)

(73) Assignee: FUJITSU LIMITED, Kawasaki-shi (JP)

(21) Appl. No.: 14/929,526

(22) Filed: Nov. 2, 2015

(30) Foreign Application Priority Data
Nov. 4, 2014 (JP) 2014-224256

(51) Int. Cl. G06F 9/54; G06F 9/445

(52) U.S. Cl. CPC G06F 9/542; G06F 9/44505

(57) ABSTRACT

A launch control apparatus stores identification information indicating the launch control apparatus and progress information indicating a progress status of a database launch process including a plurality of processes that are to be executed in a predetermined order in the launch control apparatus, in a predetermined storage region of a memory device, in response to execution of each of the processes, when executing the database launch process using the memory device. The launch control apparatus determines whether or not to continue the launch process, on the basis of statuses of the stored identification information and progress information, with reference to the predetermined storage region, in response to completion of each of the processes.

### CROSS-REFERENCE TO RELATED APPLICATION

This application is based upon and claims the benefit of priority of the prior Japanese Patent Application No. 2014-224256, filed on Nov. 4, 2014, the entire contents of which are incorporated herein by reference.

### FIELD

The embodiments discussed herein relate to a launch control method and a launch control apparatus.

### BACKGROUND

Some database systems are requested to have high availability that allows a client device to access data at any time when the client device uses the data. As a method for increasing the availability of the database system, it is conceived that a server apparatus for performing data processing, such as searching and updating, is made redundant in case a failure occurs in the server apparatus. A plurality of redundant server apparatuses are connected to a common memory device that stores data. At normal times, one of the server apparatuses launches data management software, such as a database management system (DBMS), and accesses the memory device in order to perform data processing. When a failure (for example, hardware malfunction) occurs in the server apparatus, another server apparatus launches data management software and accesses the memory device to take over the data processing.

Here, when a plurality of server apparatuses access the common memory device around the same time (particularly, try to update data around the same time), the data of the memory device is destroyed in some cases. Hence, it is preferable that the database system control a plurality of server apparatuses to not launch the data management software around the same time. With regard to launch control, one can conceive of a method in which cluster management software is installed in each server apparatus, and a plurality of server apparatuses monitor each other for launch of the data management software, using the cluster management software, for example. When a server apparatus is executing data management software, the cluster management software of the other server apparatuses prevents launch of data management software.

There is proposed a duplication memory device that allows its data to be accessed from outside even while the data is copied from one disk medium to another disk medium in order to duplicate the data. When new data arrives, this duplication memory device writes the new data into both of the two disk media. When not writing the new data, the duplication memory device copies the data from one disk medium to the other disk medium. The duplication memory device is provided with a shared table that stores a flag outside the disk media, so as to use the shared table to prevent a collision between a write process and a copy process.

See, for example, Japanese Laid-open Patent Publication No. 2001-34425.

In the meantime, when work such as maintenance is performed on some of the server apparatuses, the cluster management software is halted temporarily in some cases.

The halt of the cluster management software increases the risk of launching data management software in a plurality of server apparatuses by mistake. Thus, it is preferable to provide another method for preventing such simultaneous launch.

As another method for preventing such simultaneous launch, one may conceive of storing a flag in a common memory device. For example, each server apparatus confirms the flag stored in the memory device, when trying to launch the data management software. If the flag is OFF, the server apparatus rewrites the flag to ON and then launches the data management software. On the other hand, if the flag is already ON, the server apparatus does not launch the data management software.

However, it is sometimes difficult to obtain an exclusive lock in access to the memory device in the database system. For example, in some cases, the access to the memory device does not employ a block forwarding method in which an operating system (OS) caches data and forwards the data block by block, but a RAW device method in which the data is directly forwarded byte by byte in order to improve access performance. The RAW device method does not utilize the exclusive lock mechanism of the operating system with respect to the access to the memory device. Also, when an exclusive lock is configured between a plurality of server apparatuses that execute different operating systems, the server apparatuses cooperate through communication.

When accessing the flag stored in the common memory device without obtaining an exclusive lock, it is possible that these server apparatuses erroneously determine that the data management software is able to be launched, depending on when the server apparatuses make the access. That is, storing such a simple flag in a common memory device is not sufficient to prevent a plurality of server apparatuses from executing database launch processes simultaneously.

### SUMMARY

According to one aspect, there is provided a non-transitory computer-readable storage medium storing a computer program that causes a computer to perform a process including: storing identification information indicating the computer and progress information indicating a progress status of a database launch process including a plurality of processes that are to be executed in a predetermined order in the computer, in a predetermined storage region of a memory device, in response to execution of each of the plurality of processes, when executing the database launch process using the memory device; and determining whether or not to continue the launch process on the basis of statuses of the stored identification information and progress information, with reference to the predetermined storage region, in response to completion of each of the plurality of processes.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing system of a first embodiment;

FIG. 2 illustrates an example of an information processing system of a second embodiment;

FIG. 3 is a block diagram illustrating exemplary hardware of a server apparatus;

FIG. 4 is a block diagram illustrating an exemplary function of the server apparatus;

FIG. 5 illustrates an example of a time stamp table;

FIG. 6 illustrates an example of launch control information;

FIG. 7 is a flowchart illustrating an exemplary procedure of launch and halt control;

FIG. 8 is a flowchart (continuation) illustrating an exemplary procedure of launch and halt control;

FIG. 9 illustrates a first example of a launch process by a plurality of server apparatuses;

FIG. 10 illustrates a second example of a launch process by a plurality of server apparatuses;

FIG. 11 illustrates a third example of a launch process by a plurality of server apparatuses;

FIG. 12 illustrates a fourth example of a launch process by a plurality of server apparatuses; and

FIG. 13 illustrates a fifth example of a launch process by a plurality of server apparatuses.

### DESCRIPTION OF EMBODIMENTS

Several embodiments will be described below with reference to the accompanying drawings, wherein like reference numerals refer to like elements throughout.

### First Embodiment

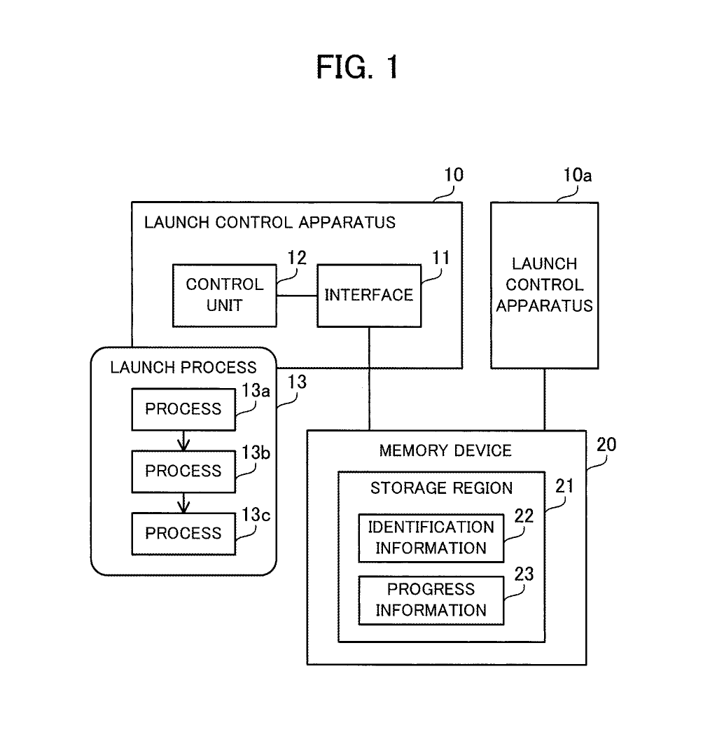

FIG. 1 illustrates an example of an information processing system of a first embodiment. The information processing system of the first embodiment includes launch control apparatuses 10 and 10a and a memory device 20. The launch control apparatuses 10 and 10a control launch of a database. The launch control apparatuses 10 and 10a constitute a redundant configuration in case of a trouble, such as a hardware malfunction and a software failure. The launch control apparatuses 10 and 10a may be server computers. The memory device 20 is a non-volatile memory device that stores data. For example, a hard disk drive (HDD) or a solid state drive (SSD) may be used as the memory device 20. The memory device 20 is connected to both of the launch control apparatuses 10 and 10a.

The launch control apparatus 10 includes an interface 11 and a control unit 12. The interface 11 accesses the memory device 20. The interface 11 and the memory device 20 are connected through a cable, such as a fiber cable. The control unit 12 controls a database launch process 13 in the launch control apparatus 10. The launch process 13 includes processes 13a, 13b, and 13c, which are executed in a predetermined order. When the process 13a ends, the process 13b is started, and when the process 13b ends, the process 13c is started. Each of the processes 13a, 13b, and 13c accesses data of a type corresponding to the process, which is stored in the memory device 20, for example.

The control unit 12 may be a processor, such as a central processing unit (CPU) and a digital signal processor (DSP). Also, the control unit 12 may include an electronic circuit of a specific use, such as an application specific integrated circuit (ASIC) and a field programmable gate array (FPGA). The processor executes a launch control program stored in a memory, such as a random access memory (RAM). Note that a group of processors (multiprocessor) is referred to as “processor”, in some cases. The launch control apparatus 10a is also configured using the same types of hardware as the launch control apparatus 10.

Here, if the launch control apparatus 10 and the launch control apparatus 10a access the memory device 20 around the same time (particularly, write data into the memory device 20 simultaneously), the data of the memory device 20 may be destroyed. Thus, the control unit 12 controls the launch control apparatuses 10 and 10a in such a manner that the database is not utilized simultaneously by both of the launch control apparatuses 10 and 10a, as described below. In this case, the launch control apparatus and the launch control apparatus 10a are needless to cooperate directly through communication. The launch control apparatus 10a performs the same launch control as the launch control apparatus 10.

When the launch control apparatus 10 executes the launch process 13, the control unit 12 stores identification information 22 and progress information 23 in a predetermined storage region 21 that is not a region for storing data in the memory device 20, in response to execution of each of the processes 13a, 13b, and 13c. The identification information 22 identifies the launch control apparatus 10. It is preferable to use, as the identification information 22, information that is unlikely to be set at the same value as the identification information of the launch control apparatus 10a. For example, a communication address, such as a medium access control (MAC) address, is used as the identification information 22. The progress information 23 indicates a progress status of the processes 13a, 13b, and 13c in the launch control apparatus 10. For example, the progress information 23 indicates the process 13a, when the launch control apparatus 10 starts the process 13a.

When the launch process 13 starts the process 13b, the control unit 12 may overwrite the information indicating the process 13a with the information indicating the process 13b to thereby update the progress information 23. Alternatively, the control unit 12 may write the information indicating the process 13b additionally, leaving the information indicating the process 13a undeleted. When the launch process 13 is executed in the launch control apparatus 10a, the identification information indicating the launch control apparatus 10a is stored in the storage region 21, either instead of the identification information 22 or leaving the identification information 22 undeleted. Also, the progress information indicating a progress status of the launch process 13 in the launch control apparatus 10a is stored in the storage region 21, either instead of the progress information 23 or leaving the progress information 23 undeleted. An exclusive lock is not used in the access to the storage region 21. Therefore, when the launch control apparatus 10 executes the launch process 13, it is possible that the launch control apparatus 10a accesses the storage region 21 at arbitrary time.

The control unit 12 refers to the storage region 21 in response to completion of each of the processes 13a, 13b, and 13c, and determines whether or not to continue the launch process 13 in the launch control apparatus 10, on the basis of statuses of the stored identification information 22 and progress information 23. When determining to continue the launch process 13, the control unit 12 stores the identification information 22 and the progress information 23 which indicate the next process in the storage region 21, and starts the next process. Whether or not to continue the launch process 13 is determined in consideration of the possibility that the launch control apparatus 10a is also executing the launch process 13.

For example, it is envisaged that the identification information indicating the launch control apparatus 10a is not stored in the storage region 21. In this case, the control unit 12 determines that the launch process 13 is not executed in the launch control apparatus 10a, and determines to continue the launch process 13. Also, for example, it is envisaged that the identification information indicating the launch control apparatus 10a is stored in the storage region 21, and the stored progress information indicates a process prior to the process that the launch control apparatus 10 executes next. In this case, the control unit 12 determines that it is preferable to prioritize the launch control apparatus 10, and determines to continue the launch process 13. Also, for example, it is envisaged that the identification information indicating the launch control apparatus 10a is stored in the storage region 21, and the already-stored progress information indicates a process that the launch control apparatus 10 executes next or a process after that process. In this case, the control unit 12 determines that it is preferable to prioritize the launch control apparatus 10a, and determines not to continue the launch process 13.

According to the information processing system of the first embodiment, the identification information 22 indicating the launch control apparatus 10 and the progress information 23 indicating a progress status of the processes in the launch control apparatus 10 are stored, in response to execution of each of the processes 13a, 13b, and 13c. Then, whether or not to continue the launch process 13 in the launch control apparatus 10 is determined on the basis of the statuses of the stored identification information 22 and progress information 23 in the storage region 21, in response to completion of each of the processes 13a, 13b, and 13c.

Thereby, each launch control apparatus can determine whether the launch process 13 is executed in the other launch control apparatus, in order to prevent the launch control apparatuses 10 and 10a from utilizing the database simultaneously. Thus, the launch control apparatuses 10 and 10a are prevented from simultaneously accessing the data of the memory device 20, so as to prevent the data of the memory device 20 from being destroyed.

Also, since the storage region 21 is referred when each of the processes 13a, 13b, and 13c ends, the possibility to overlook the operation of the other launch control apparatus is reduced, even without using an exclusive lock in the access to the storage region 21. Thereby, the cost of the exclusive lock is made unnecessary, and the access to the storage region 21 is made efficient. Also, for example, since whether or not to continue the launch process 13 is determined on the basis of the progress information 23, the launch process 13 of the launch control apparatus that is more advanced is prioritized, while the launch process 13 of the launch control apparatus that is behind is halted. Thereby, the database is launched promptly, even when the launch process 13 contends.

### Second Embodiment

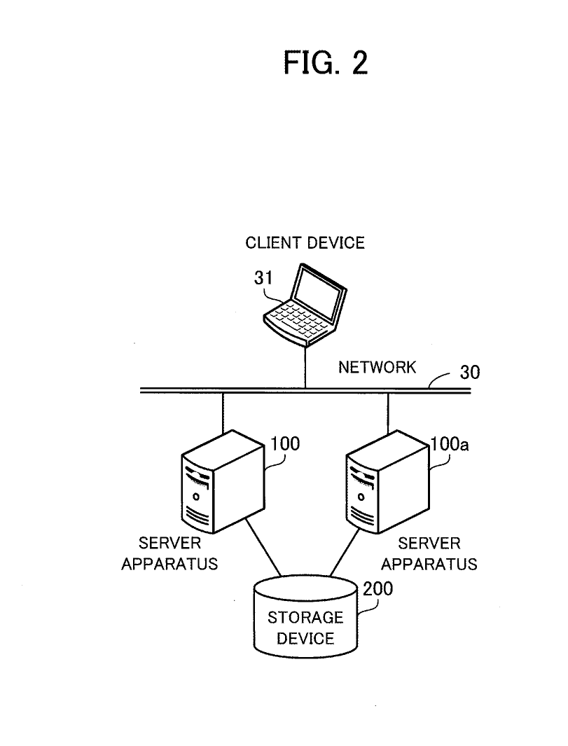

FIG. 2 illustrates an example of information processing system of the second embodiment. The information processing system of the second embodiment includes a client device 31, server apparatuses 100 and 100a, and a storage device 200. The client device 31 and the server apparatuses 100 and 100a are connected to a network 30. The network 30 may include a wide area network, such as the Internet, and a local area network (LAN). The storage device 200 is connected to both of the server apparatuses 100 and 100a.

Note that the server apparatus 100 is an example of the launch control apparatus 10 of the first embodiment.

The server apparatus 100a is an example of the launch control apparatus 10a of the first embodiment. The storage device 200 is an example of the memory device 20 of the first embodiment.

The client device 31 is a client computer that accesses the server apparatuses 100 and 100a. The client device 31 may be a terminal device operated by a user. The client device 31 transmits a request message to one of the server apparatuses 100 and 100a via the network 30, when retrieving or updating the data managed by the server apparatuses 100 and 100a. The transmission destination of the request message is the server apparatus that executes a DBMS, which is detected by the client device 31 in advance. The client device 31 receives a reply message including requested data or an update result, via the network 30.

The server apparatuses 100 and 100a are server computers that manage a database. The server apparatuses 100 and 100a may be referred to as database server. The server apparatuses 100 and 100a constitute a redundant configuration in case of a failure such as a hardware malfunction and software abort. That is, at normal times, only one of the server apparatuses 100 and 100a executes the DBMS and manages the database in the storage device 200. When a failure occurs in a server apparatus that is executing the DBMS, the other server apparatus launches the DBMS to take over the management of the database in the storage device 200.

The server apparatus that is executing the DBMS occasionally receives a request message indicating retrieval or update of data, from the client device 31. When receiving a request message of data retrieval, the server apparatus searches the storage device 200 for the requested data, and returns a reply message including the requested data to the client device 31. When receiving a request message of data update, the server apparatus updates the data of the storage device 200, and returns a reply message indicating success or failure of the update to the client device 31.

The storage device 200 is a non-volatile memory device for storing data. For example, a HDD or a SSD may be used as the storage device 200. The storage device 200 is connected to both of the server apparatuses 100 and 100a via cables, such as fiber cable. Data transmission between the server apparatuses 100 and 100a and the storage device 200 is performed by the RAW device method in which data is not transmitted block by block but byte by byte directly. The server apparatuses 100 and 100a access the storage device 200 independently. Access from the server apparatus 100 and access from the server apparatus 100a are not controlled exclusively by exclusive lock, even when these two accesses contend with each other. Thus, when both of the server apparatuses 100 and 100a execute a write simultaneously, data can be destroyed.

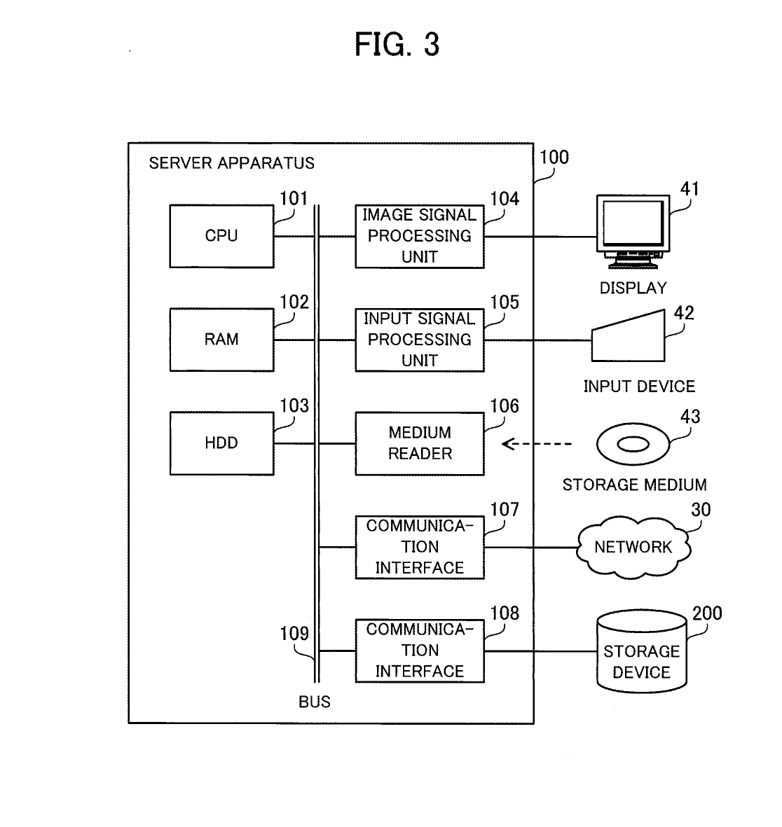

FIG. 3 is a block diagram illustrating exemplary hardware of the server apparatus. The server apparatus 100 includes a CPU 101, a RAM 102, an HDD 103, an image signal processing unit 104, an input signal processing unit 105, a medium reader 106, and communication interfaces 107 and 108. Each of the above units is connected to a bus 109. Note that the CPU 101 is an example of the control unit 12 of the first embodiment. The communication interface 108 is an example of the interface 11 of the first embodiment.

The CPU 101 is a processor including a computing circuit that executes commands of programs. The CPU 101 loads at least part of programs and data stored in the HDD 103 into the RAM 102, and executes the programs. Note that the CPU 101 may include a plurality of processor cores, and the server 100 may include a plurality of processors. Processes described below may be executed in parallel using processors or processor cores. Also, a group of processors (multiprocessor) may be called “processor”.

The RAM 102 is a volatile semiconductor memory that temporarily stores programs executed by the CPU 101 and data that the CPU 101 uses in calculation. Note that the server 100 may include a memory of a type other than RAM, and may include a plurality of memories.

The HDD 103 is a non-volatile memory device for storing software programs, such as an OS, middleware, and application software, and data. The programs include a launch control program that controls the launch of the database. Note that the server apparatus 100 may include a memory device of another type, such as a flash memory and an SSD, and may include a plurality of non-volatile memory devices.

The image signal processing unit 104 outputs an image to a display 41 connected to the server apparatus 100, in accordance with a command from the CPU 101. A cathode ray tube (CRT) display, a liquid crystal display (LCD), a plasma display panel (PDP), an organic electro-luminescence (OEL) display, or the like may be used as the display 41.

The input signal processing unit 105 receives an input signal from an input device 42 that is connected to the server apparatus 100, and outputs it to the CPU 101. A pointing device, such as a mouse, a touch panel, a touch pad, and a trackball, a keyboard, a remote controller, a button switch, and the like may be used as the input device 42. Also, a plurality of types of input devices may be connected to the server 100.

The medium reader 106 is a reader device that reads programs and data that are stored in a storage medium 43. For example, a magnetic disk such as a flexible disk (FD) and an HDD, an optical disc such as a compact disc (CD) and a digital versatile disc (DVD), a magneto-optical disk (MO), a semiconductor memory, or the like may be used as the storage medium 43. The medium reader 106 stores the programs and data, which are read from the storage medium 43, in the RAM 102 or the HDD 103, for example.

The communication interface 107 is connected to the network 30 to communicate with the client device 31 and the server apparatus 100a. The communication interface 107 is connected to a relay device, such as a switch, using a LAN cable, for example. The communication interface 108 is connected to the storage device 200. For example, a fiber cable is used to connect between the communication interface 108 and the storage device 200.

Note that the server apparatus 100 may be configured without the medium reader 106, and may be configured without the image signal processing unit 104 and the input signal processing unit 105 when controllable from a terminal device operated by a user. Also, the display 41 and the input device 42 may be formed integrally in a housing of the server apparatus 100. The server apparatus 100a may also be configured by the same hardware configuration as the server apparatus 100.

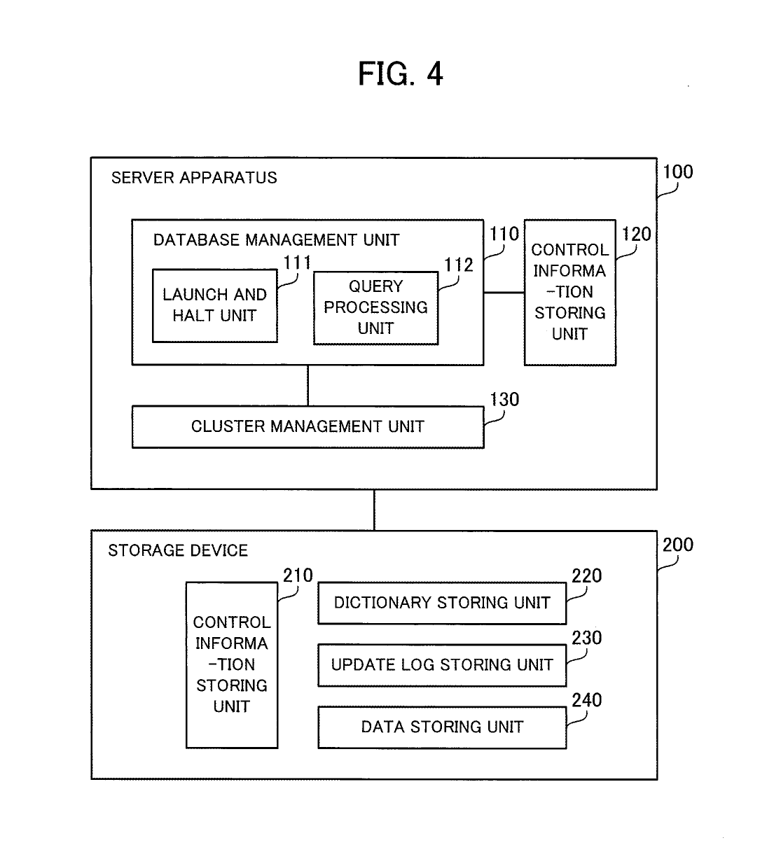

FIG. 4 is a block diagram illustrating an exemplary function of the server apparatus. The server apparatus 100 includes a database management unit 110, a control information storing unit 120, and a cluster management unit 130. The database management unit 110 and the cluster management unit 130 are implemented as a module of software which is executed using the CPU 101, for example. The control information storing unit 120 is configured as a storage region allocated in the RAM 102 or the HDD 103, for example. The server apparatus 100a includes a database management unit, a control information storing unit, and a cluster management unit, in the same way as the server apparatus 100.

The database management unit 110 provides a function of a database. The database management unit 110 is implemented as data management software, such as a DBMS, for example. The database management unit 110 includes a launch and halt unit 111 and a query processing unit 112.

The launch and halt unit 111 launches the database management unit 110 in the server apparatus 100. Also, the launch and halt unit 111 halts the database management unit 110 in execution. The launch of the database management unit 110 is triggered, for example, when the power supply of the server apparatus 100 turns on, when a predetermined date and time arrives, when a user inputs a launch command, and when a failure occurs in the server apparatus 100a. The halt of the database management unit 110 is triggered, for example, when the power supply of the server apparatus 100 turns off, when a predetermined date and time arrives, and when a user inputs a halt command.

The query processing unit 112 executes data processing according to a request message received from the client device 31. The request of data processing is expressed as a query described in a predetermined language. In response to a query of data retrieval, the query processing unit 112 searches the storage device 200 to retrieve data, and transmits a reply message including the retrieved data to the client device 31. In response to a query of data update, the query processing unit 112 writes data into the storage device 200, and transmits a reply message indicating a result of the write to the client device 31.

The control information storing unit 120 stores control information used by the database management unit 110. The control information stored in the control information storing unit 120 includes a time stamp table, which is described later. The time stamp table is used in a database launch process.

The cluster management unit 130 manages a cluster configuration of the server apparatuses 100 and 100a. The cluster management unit 130 communicates with a cluster management unit of the server apparatus 100a, in order to control the server apparatus 100 such that only one of the server apparatuses 100 and 100a executes the database management unit 110. When the database management unit has been launched already in the server apparatus 100a, the cluster management unit 130 does not launch the database management unit 110. When a failure occurs in the server apparatus 100a, the cluster management unit 130 instructs the launch and halt unit 111 to launch the database management unit 110.

In the second embodiment, the power supplies of both of the server apparatuses 100 and 100a are turned on, to promptly switch between the server apparatuses 100 and 100a when a failure occurs. In each of the server apparatuses 100 and 100a, the cluster management units are in execution basically any time while the power supplies are in an ON state. Note that, when maintenance work, such as update of software, is performed for at least one of the server apparatuses 100 and 100a, its cluster management unit is halted temporarily. For example, when maintenance work is performed for the server apparatus 100a while the server apparatus 100 is used as a currently active system, it is preferable in some cases to prevent the currently active system from being switched to the server apparatus 100a, even though a failure occurs in the server apparatus 100. In that case, the cluster management units of the server apparatuses 100 and 100a can be temporarily halted by user operation.

The storage device 200 includes a control information storing unit 210, a dictionary storing unit 220, an update log storing unit 230, and a data storing unit 240. The control information storing unit 210, the dictionary storing unit 220, the update log storing unit 230, and the data storing unit 240 are configured as a storage region allocated in the HDD of the storage device 200, for example. Note that the control information storing unit 210 is an example of the storage region 21 of the first embodiment.

The control information storing unit 210 stores control information used by the database management units of the server apparatuses 100 and 100a. A predetermined storage region other than the storage regions used by the dictionary storing unit 220, the update log storing unit 230, and the data storing unit 240 is used as the control information storing unit 210. The control information stored in the control information storing unit 210 includes launch control information, which is described later. The launch control information is used in the database launch processes by the server apparatuses 100 and 100a, to prevent the launch processes from being executed simultaneously. An exclusive lock is not used in the access from the server apparatuses 100 and 100a to the control information storing unit 210.

The dictionary storing unit 220 stores dictionary information indicating a structure of the data stored in the storage device 200. The dictionary information is created by a user in advance when designing the database. When the database is a relational database (RDB), the dictionary information indicates the definition of a relational table, such as name, data type, data length, unique constraint, NOT NULL constraint, and default value of each column included in the relational table.

The update log storing unit 230 stores an update log indicating a history of data writes into the data storing unit 240. Before data is written into the data storing unit 240, a record of writing (for example, a pointer to a record of update target, a value before update, and a value after update) is written into the update log. If at least one of the server apparatuses 100 and 100a and the storage device 200 halts abnormally before the data write into the data storing unit 240 ends, the database can halt abnormally. In this case, it is possible that the integrity of the data stored in the data storing unit 240 is impaired. Thus, the database is restored, using the update log stored in the update log storing unit 230.

The data storing unit 240 stores the data of the database. When the database is an RDB, the data storing unit 240 stores one or two or more relational tables defined by the dictionary information stored in the dictionary storing unit 220. The relational table includes one or two or more columns one or two or more tuples (records).

In the meantime, the database launch process executed by the launch and halt unit 111 includes confirming the update log stored in the update log storing unit 230, and restoring the data stored in the data storing unit 240 on the basis of the update log. In the second embodiment, the launch process includes three stages. The three stages correspond to three storage regions of the storage device 200, that is, the dictionary storing unit 220, the update log storing unit 230 and the data storing unit 240.

Stage 0 includes reading the dictionary information from the dictionary storing unit 220. Stage 1 includes reading the update log from the update log storing unit 230. Stage 2 includes updating the data stored in the data storing unit 240 with reference to the dictionary information and update log which have been read. For example, the launch and halt unit 111 reflects in the data storing unit 240 the data that is in the history of the data writes indicated by the update log but has not been reflected in the data storing unit 240,.

In the database launch process, stage 0 is first started, and the end of stage 0 is followed by the start of stage 1, and the end of stage 1 is followed by the start of stage 2. When stage 2 ends, the database launch process is completed. It takes approximately several seconds to 10 seconds for the launch and halt unit 111 to execute stage 0 and stage 1, for example. It takes approximately several ten seconds for the launch and halt unit 111 to execute stage 2, for example.

As described above, in some cases, the cluster management unit 130 is temporarily halted when the launch and halt unit 111 executes the database launch process. Thus, during the launch process, the launch and halt unit 111 refers to the launch control information stored in the control information storing unit 210 at appropriate times, so as not to launch the database simultaneously even when the cluster management unit 130 is halted.

Specifically, the launch and halt unit 111 executes read (Read #0A), update (Write #0), and reread (Read #0B) of the launch control information in this order, before starting stage 0. Whether or not to continue the launch process is determined at the first read, and whether there has been an interrupt from the accessing server apparatus 100a is determined at the second read. In the same way, the launch and halt unit 111 executes read (Read #1A), update (Write #1), reread (Read #1B) of the launch control information in this order, before starting stage 1. Also, the launch and halt unit 111 executes read (Read #2A), update (Write #2), reread (Read #2B) of the launch control information in this order, before starting stage 2.

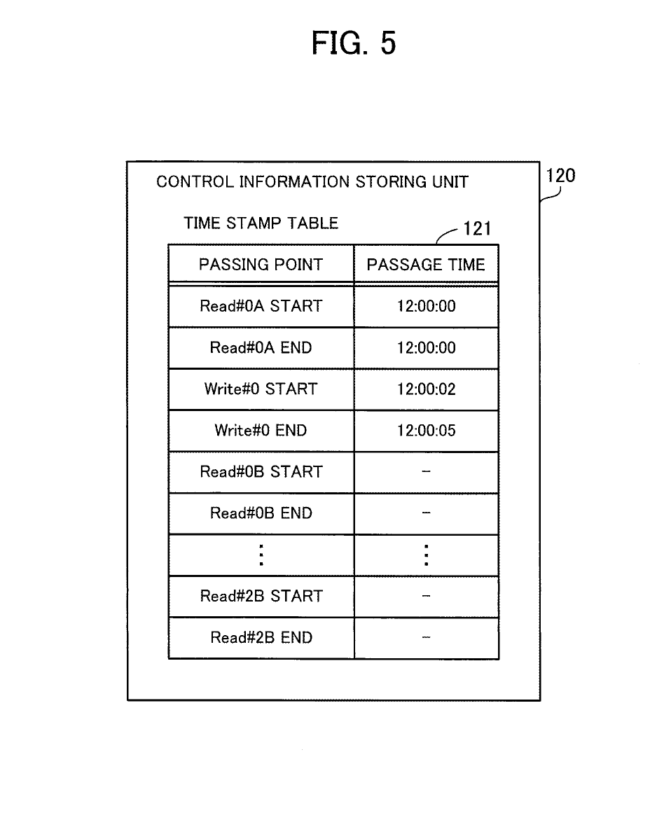

FIG. 5 illustrates an example of the time stamp table. The time stamp table 121 is stored in the control information storing unit 120 of the server apparatus 100. The passage times are stored in the time stamp table 121 in association with corresponding passing points in the launch process, while executing the database launch process. The time stamp table 121 may be initialized when starting or ending the launch process. The same time stamp table is also stored in the control information storing unit of the server apparatus 100a.

The passing points immediately before stage 0 include a time point at which Read #0A started, a time point at which Read #0A ended, a time point at which Write #0 started, a time point at which Write #0 ended, a time point at which Read #0B started, and a time point at which Read #0B ended. In the same way, the passing points immediately before stage 1 include a time point at which Read #1A started, a time point at which Read #1A ended, a time point at which Write #1 started, a time point at which Write #1 ended, a time point at which Read #1B started, and a time point at which the Read #1B ended. Also, the passing points immediately before stage 2 include a time point at which Read #2A started, a time point at which Read #2A ended, a time point at which Write #2 started, a time point at which Write #2 ended, a time point at which Read #2B started, and a time point at which the Read #2B ended.

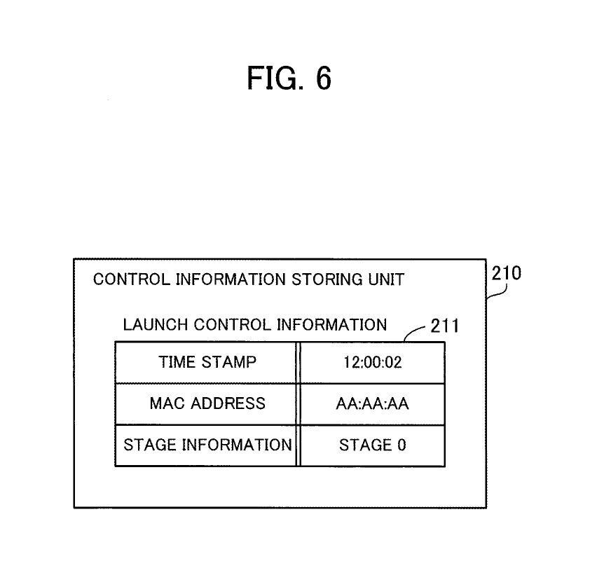

FIG. 6 illustrates an example of the launch control information. The launch control information 211 is stored in the control information storing unit 210 of the storage device 200. The launch control information 211 includes fields of time stamp, MAC address, and stage information. The time stamp indicates a time at which the launch control information 211 is updated last time. The MAC address indicates a server apparatus that has updated the launch control information 211 last time, which is one of the server apparatuses 100 and 100a. The stage information indicates a process that is scheduled to be executed next at the time point of updating by the server apparatus that has updated the launch control information 211 last time.

The stage information is a value indicating one of OFF, stage 0, stage 1, stage 2, and completion, for example. “OFF” indicates that the database is not launched in both of the server apparatuses 100 and 100a. “Stage 0” indicates that stage 0 is started by the server apparatus that has updated the launch control information 211 last time. “Stage 1” indicates that stage 1 is started by the server apparatus that has updated the launch control information 211 last time. “Stage 2” indicates that stage 2 is started by the server apparatus that has updated the launch control information 211 last time. “Completed” indicates that the launch process is completed by the server apparatus that has updated the launch control information 211 last time, in other words, stage 2 is completed.

Note that, in the second embodiment, a MAC address is used as the identification information for identifying the server apparatuses 100 and 100a. A host name is a name that a user arbitrarily sets to each of the server apparatuses 100 and 100a, and entails a risk that a same name is set to the server apparatus 100 and the server apparatus 100a. A virtual IP address is used in the field of clustering, and therefore an Internet protocol (IP) address entails a risk that a same name is set to the server apparatus 100 and the server apparatus 100a. On the other hand, a MAC address is basically a physical address set to a communication interface, and has little possibility that a same name is set.

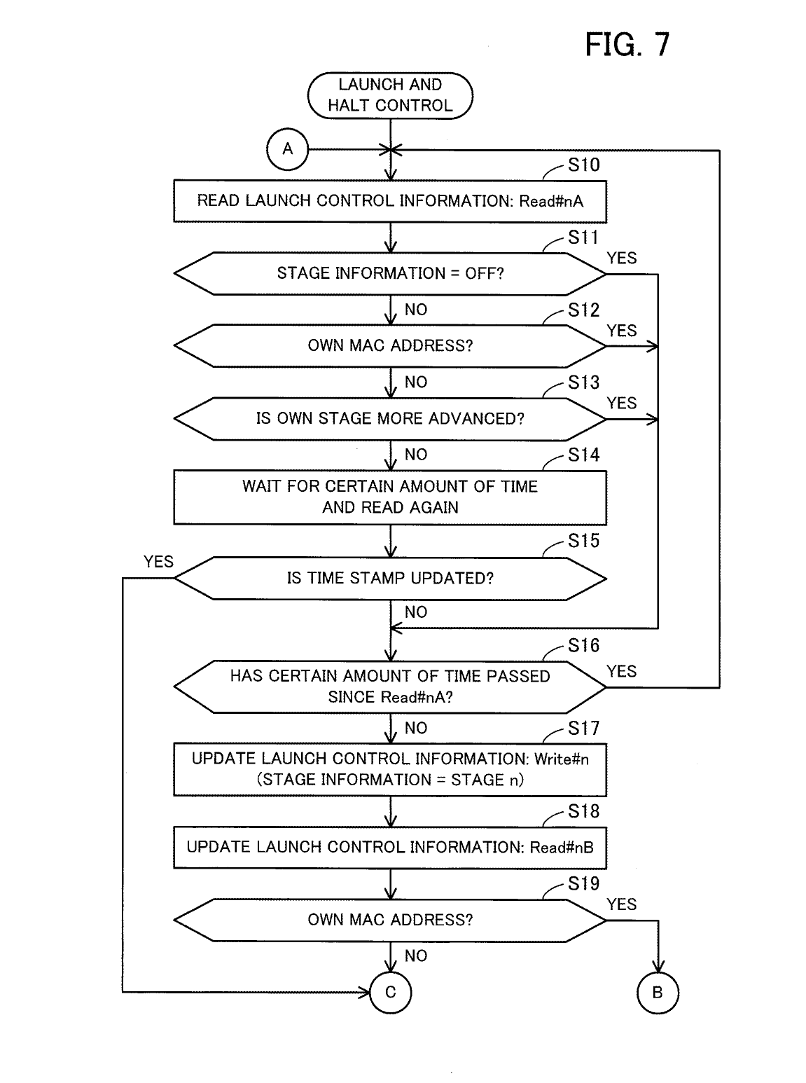

FIG. 7 is a flowchart illustrating an exemplary procedure of the launch and halt control. In the following, the server apparatus 100 executes a database launch process. The server apparatus 100a can execute the same process as FIG. 7.

(S10) The launch and halt unit 111 reads the launch control information 211 from the control information storing unit 210 of the storage device 200 (Read #nA). Here, n indicates the number of a stage to be executed next, which is one of 0, 1, and 2. When starting the database launch process, n is 0, and then proceeds to 1, and proceeds to 2 lastly.

(S11) The launch and halt unit 111 determines whether the stage information included in the launch control information 211 is OFF. If the stage information is OFF, the database has not been launched and is not being launched in both of the server apparatuses 100 and 100a. In this case, since the server apparatus 100 can execute the launch process, the process proceeds to step S16. If the stage information is not OFF, the database has been launched already or is being launched in at least one of the server apparatuses 100 and 100a. In this case, the process proceeds to step S12.

(S12) The launch and halt unit 111 determines whether the MAC address in the launch control information 211 is the MAC address of the server apparatus 100. If it is the MAC address of the server apparatus 100, the launch process has not progressed in the server apparatus 100a, since the server apparatus 100 updated the launch control information 211 last time. In this case, since the server apparatus 100 can progress the launch process, the process proceeds to step S16. If it is not the MAC address of the server apparatus 100 (if it is the MAC address of the server apparatus 100a), the database has been launched already or is being launched in the server apparatus 100a. In this case, the process proceeds to step S13.

(S13) The launch and halt unit 111 determines whether the stage information of the launch control information 211 indicates a stage before the stage that the server apparatus 100 starts next, that is, whether the server apparatus 100 is in a more advanced stage than the server apparatus 100a. If the server apparatus 100 is in a more advanced stage, the process proceeds to step S16, to prioritize the launch process of the server apparatus 100 over the launch process of the server apparatus 100a. If the server apparatus 100 is not necessarily in a more advanced stage, the process proceeds to step S14.

(S14) Considering the possibility that the server apparatus 100a halts abnormally, the launch and halt unit 111 waits for a certain amount of time (for example, approximately 3 minutes) and again reads the launch control information 211 from the control information storing unit 210 (re-execute Read #nA of step S10).

(S15) The launch and halt unit 111 determines whether the time stamp included in the launch control information 211 read in step S14 has been updated since read in step S10. If the time stamp has been updated, the server apparatus 100a is determined to operate normally, and the process proceeds to step S27. If the time stamp has not been updated, the server apparatus 100a is determined to have halted abnormally, and the process proceeds to step S16.

(S16) The launch and halt unit 111 determines whether a certain amount of time has passed, since executing Read #nA last time (step S10 or step S14). This certain amount of time is a time it takes for the server apparatus 100a to execute stage 0 and 1, which is for example approximately several seconds to 10 seconds. The time at which Read #nA is executed last time can be searched for from the time stamp table 121. If a certain amount of time has passed since the last Read #nA, it is possible that the server apparatus 100a has updated the launch control information 211, and therefore the process proceeds to step S10. If it is within a certain amount of time since the last Read #nA, the process proceeds to step S17.

(S17) The launch and halt unit 111 updates the launch control information 211 stored in the control information storing unit 210 (Write #n). In this case, the launch and halt unit 111 writes a current time as the time stamp, and writes the MAC address of the server apparatus 100 as the MAC address of the launch control information 211, and writes stage n as the stage information. Stage n is a stage that the server apparatus 100 tries to execute next.

(S18) The launch and halt unit 111 reads the launch control information 211 from the control information storing unit 210 in consideration of interrupt from the accessing server apparatus 100a (Read #nB).

(S19) The launch and halt unit 111 determines whether the MAC address in the launch control information 211 read in step S18 is the MAC address of the server apparatus 100. If it is the MAC address of the server apparatus 100, the process proceeds to step S20. If it is not the MAC address of the server apparatus 100 (if it is the MAC address of the server apparatus 100a), the server apparatus 100a has updated the launch control information 211 since Write #n of step S17 and by Read #nB of step S18. In this case, the launch process of the server apparatus 100a is determined to be prioritized, and the process proceeds to step S27.

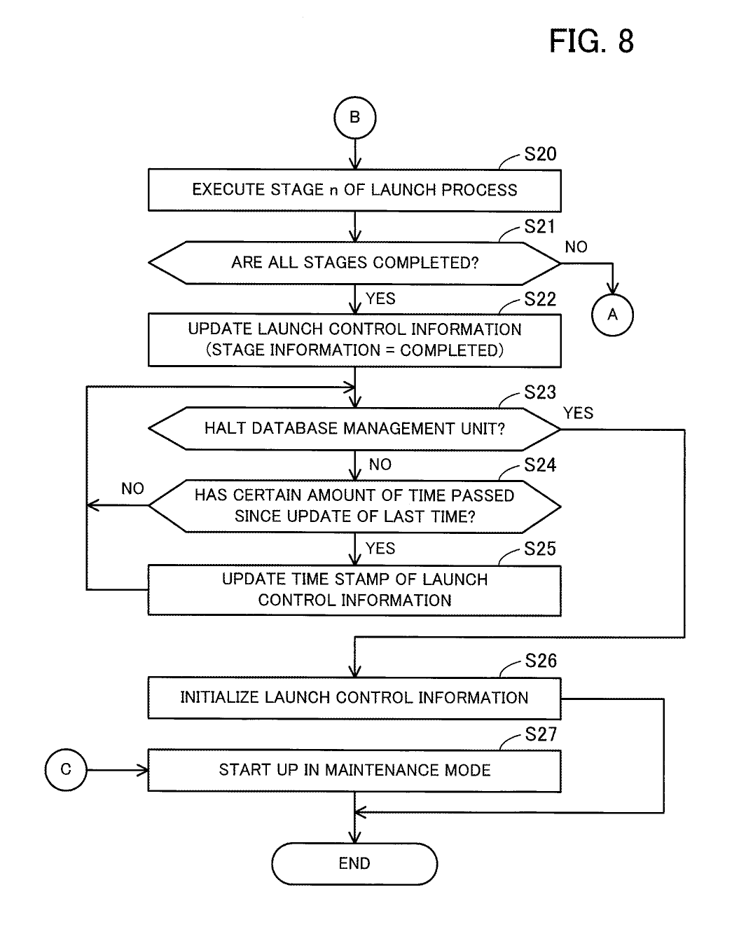

FIG. 8 is a flowchart (continuation) illustrating the exemplary procedure of the launch and halt control.

(S20) The launch and halt unit 111 executes stage n of the launch process. In the case of stage 0, the launch and halt unit 111 reads the dictionary information from the dictionary storing unit 220 of the storage device 200. In the case of stage 1, the launch and halt unit 111 reads the update log from the update log storing unit 230 of the storage device 200. In the case of stage 2, the launch and halt unit 111 updates the data of the data storing unit 240 of the storage device 200, on the basis of the dictionary information and the update log.

(S21) The launch and halt unit 111 determines whether all stages of the launch process have ended, that is, whether stage 2 is executed in step S20. If all stages have ended, the process proceeds to step S22. If there is a stage that has not ended, n is incremented by 1, and the process proceeds to step S10 in order to proceed to the next stage.

(S22) The launch and halt unit 111 updates the launch control information 211 stored in the control information storing unit 210. In this case, the launch and halt unit 111 writes a current time as the time stamp, and writes the MAC address of the server apparatus 100 as the MAC address of the launch control information 211, and writes “completed” as the stage information.

(S23) The launch and halt unit 111 determines whether to halt the database management unit 110. The halt of the database management unit 110 is triggered, for example, when a user inputs a halt command. If the database management unit 110 is to be halted, the process proceeds to step S26. Otherwise, the process proceeds to step S24.

(S24) The launch and halt unit 111 determines whether a certain amount of time (for example, 1 minute) has passed, since updating the launch control information 211 last time in step S22 or S25. If a certain amount of time has passed, the process proceeds to step S25. Otherwise, the process proceeds to step S23.

(S25) The launch and halt unit 111 updates the launch control information 211 stored in the control information storing unit 210. In this case, the launch and halt unit 111 writes a current time as the time stamp. The MAC address and the stage information may be written and may be unwritten in the launch control information 211. Then, the process proceeds to step S23.

(S26) The launch and halt unit 111 initializes the launch control information 211. For example, the launch and halt unit 111 clears the fields of the time stamp and the MAC address of the launch control information 211, and updates the stage information with “OFF”. Then, the launch and halt control ends.

(S27) The launch and halt unit 111 cancels execution of the following stage and launches the database management unit 110 in the maintenance mode. In the maintenance mode, a write into the storage device 200 is prevented basically any time. It may be such that the query processing unit 112 does not process a request message received from the client device 31. Note that the database management unit 110 can read from the storage device 200 and write into the storage device 200 on the basis of a management command input from a user.

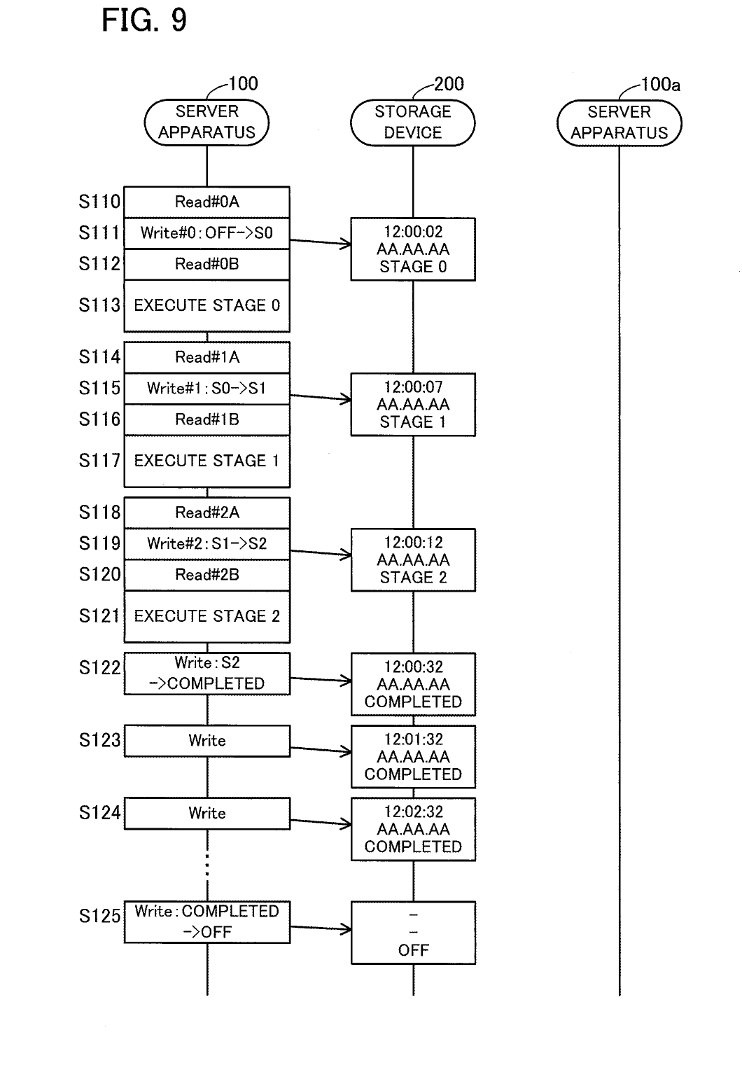

FIG. 9 illustrates the first example of launch processes by a plurality of server apparatuses. In the first example, only the server apparatus 100 executes a launch process.

The server apparatus 100 starts a database launch process to execute Read #0A before starting stage 0 (S110). After confirming that the stage information is “OFF”, the server apparatus 100 executes Write #0 (S111). Here, the time stamp is rewritten to “12:00:02”, and the MAC address is rewritten to “AA.AA.AA”, and the stage information is rewritten to “stage 0”. Thereafter, the server apparatus 100 executes Read #0B to confirm that the MAC address is not updated (S112). Then, the server apparatus 100 starts stage 0 (S113).

After stage 0 ends, the server apparatus 100 executes Read #1A, before starting stage 1 (S114). After confirming that the MAC address is of the server apparatus 100, the server apparatus 100 executes Write #1 (S115). Here, the time stamp is rewritten to “12:00:07”, and the MAC address is rewritten to “AA.AA.AA”, and the stage information is rewritten to “stage 1”. Thereafter, the server apparatus 100 executes Read #1B to confirm that the MAC address is not updated (S116). Then, the server apparatus 100 starts stage 1 (S117).

After stage 1 ends, the server apparatus 100 executes Read #2A, before starting stage 2 (S118). After confirming that the MAC address is of the server apparatus 100, the server apparatus 100 executes Write #2 (S119). Here, the time stamp is rewritten to “12:00:12”, and the MAC address is rewritten to “AA.AA.AA”, and the stage information is rewritten to “stage 2”. Thereafter, the server apparatus 100 executes Read #2B to confirm that the MAC address is not updated (S120). Then, the server apparatus 100 starts stage 2 (S121).

After stage 2 ends, the server apparatus 100 updates the launch control information 211 (S122). Here, the time stamp is rewritten to “12:00:32”, and the MAC address is rewritten to “AA.AA.AA”, and the stage information is rewritten to “completed”. In the following, the server apparatus 100 rewrites the time stamp on a regular basis (for example, at 1 minute intervals) (S123, S124). When halting the operation of the database, the server apparatus 100 initializes the launch control information 211 (S125). Here, the stage information is rewritten to “OFF”.

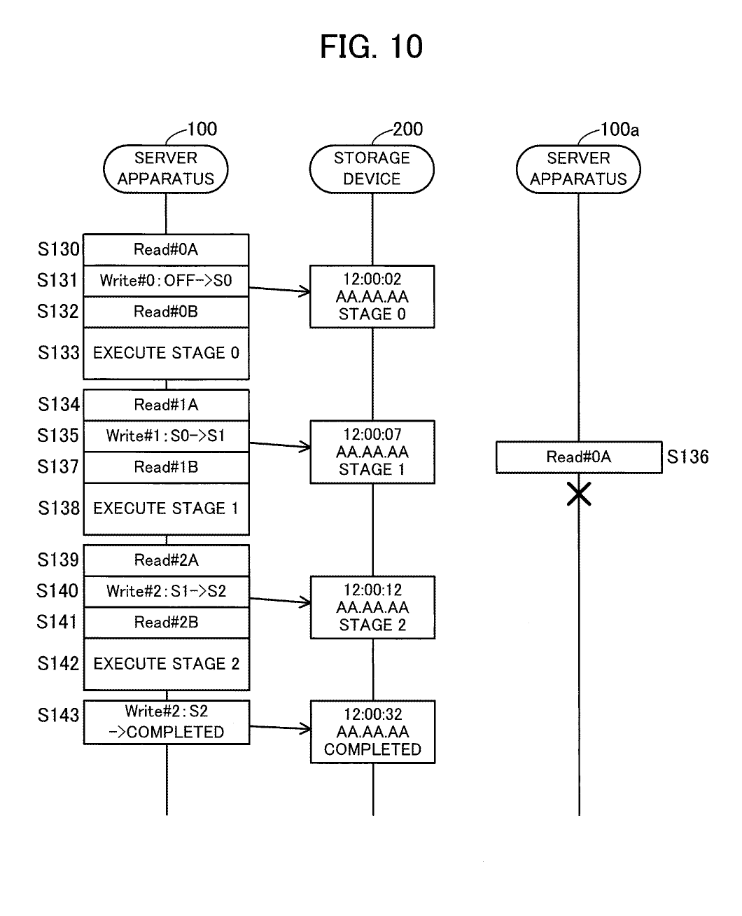

FIG. 10 illustrates the second example of launch processes by a plurality of server apparatuses. In the second example, it is obvious that the launch process of the server apparatus 100 is more advanced, at a time point when the server apparatus 100a starts a launch process. The server apparatus 100 executes Read #0A

(S130). After confirming that the stage information is “OFF”, the server apparatus 100 executes Write #0 (S131). Here, the time stamp is rewritten to “12:00:02”, and the MAC address is rewritten to “AA.AA.AA”, and the stage information is rewritten to “stage 0”. The server apparatus 100 executes Read #0B (S132) and starts stage 0 (S133).

After stage 0 ends, the server apparatus 100 executes Read #1A (S134). After confirming that the MAC address is of the server apparatus 100, the server apparatus 100 executes Write #1 (S135). Here, the time stamp is rewritten to “12:00:07”, and the MAC address is rewritten to “AA.AA.AA”, and the stage information is rewritten to “stage 1”. Immediately after Write #1, the server apparatus 100a starts the database launch process to execute Read #0A (S136).

Since the MAC address is not of the server apparatus 100a, and the stage information is “stage 1”, the server apparatus 100a does not execute Write #0. The server apparatus 100a re-executes Read #0A to confirm that the time stamp is updated, and thereafter cancels stages 0, 1, and 2 to start up in the maintenance mode. On the other hand, the server apparatus 100 executes Read #1B to confirm that the MAC address is not updated (S137). Then, the server apparatus 100 starts stage 1 (S138).

After stage 1 ends, the server apparatus 100 executes Read #2A (S139). After confirming that the MAC address is of the server apparatus 100, the server apparatus 100 executes Write #2 (S140). Here, the time stamp is rewritten to “12:00:12”, and the MAC address is rewritten to “AA.AA.AA”, and the stage information is rewritten to “stage 2”. The server apparatus 100 executes Read #2B (S141) and starts stage 2 (S142). After stage 2 ends, the server apparatus 100 updates the launch control information 211 (S143). Here, the time stamp is rewritten to “12:00:32”, and the MAC address is rewritten to “AA.AA.AA”, and the stage information is rewritten to “completed”.

As described above, the launch process of the server apparatus 100a is cancelled, when the launch process of the server apparatus 100 is more advanced at a time point when the server apparatus 100a starts a launch process.

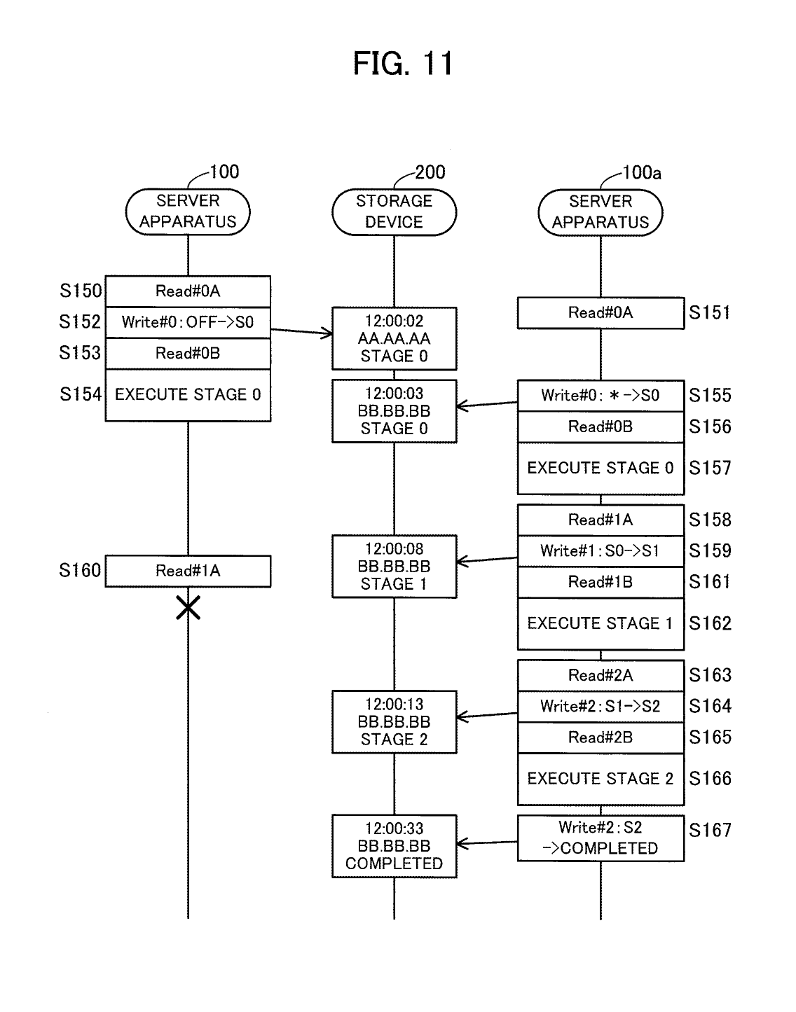

FIG. 11 illustrates the third example of launch processes by a plurality of server apparatuses. In the third example, the server apparatus 100 starts a launch process first, but the server apparatus 100a overtakes the launch process of the server apparatus 100 halfway.

The server apparatus 100 starts a database launch process to execute Read #0A (S150). Following the server apparatus 100, the server apparatus 100a also starts a database launch process to execute Read #0A (S151). An exclusive lock is not used in the access to the launch control information 211, and therefore both of the server apparatus 100 and the server apparatus 100a recognize that the stage information is “OFF”.

Then, the server apparatus 100 executes Write #0 (S152). Here, the time stamp is rewritten to “12:00:02”, and the MAC address is rewritten to “AA.AA.AA”, and the stage information is rewritten to “stage 0”. The server apparatus 100 executes Read #0B (S153) and starts stage 0 (S154). On the other hand, the server apparatus 100a, also recognizes that the stage information is “OFF”, and therefore executes Write #0 (S155). Here, the time stamp is rewritten to “12:00:03”, and the MAC address is rewritten to “BB.BB.BB”, and the stage information is rewritten to “stage 0”. The server apparatus 100a executes Read #0B (S156) and starts stage 0 (S157).

After stage 0 ends, the server apparatus 100a executes Read #1A (S158). After confirming that the MAC address is of the server apparatus 100a, the server apparatus 100a executes Write #1 (S159). Here, the time stamp is rewritten to “12:00:08”, and the MAC address is rewritten to “BB.BB.BB”, and the stage information is rewritten to “stage 1”. On the other hand, after stage 0 ends, the server apparatus 100 executes Read #1A (S160). Since the MAC address is not of the server apparatus 100, and the stage information is “stage 1”, the server apparatus 100 does not execute Write #1. The server apparatus 100 re-executes Read #1A to confirm that the time stamp is updated, and thereafter cancels stages 1 and 2 to start up in the maintenance mode. The server apparatus 100a executes Read #1B (S161) and starts stage 1 (S162).

After stage 1 ends, the server apparatus 100a executes Read #2A (S163). After confirming that the MAC address is of the server apparatus 100a, the server apparatus 100a executes Write #2 (S164). Here, the time stamp is rewritten to “12:00:13”, and the MAC address is rewritten to “BB.BB.BB”, and the stage information is rewritten to “stage 2”. The server apparatus 100a executes Read #2B (S165) and starts stage 2 (S166). After stage 2 ends, the server apparatus 100a updates the launch control information 211 (S167). Here, the time stamp is rewritten to “12:00:33”, and the MAC address is rewritten to “BB.BB.BB”, and the stage information is rewritten to “completed”.

As described above, since an exclusive lock is not used for the launch control information 211, it is possible that both of the server apparatus 100 and the server apparatus 100a read the stage information “OFF” and start stage 0. However, each time one stage is completed, the server apparatuses 100 and 100a can detect that the launch processes are progressing simultaneously in the server apparatuses 100 and 100a, with reference to the launch control information 211. Thereby, only one of the server apparatuses 100 and 100a starts the operation of the database.

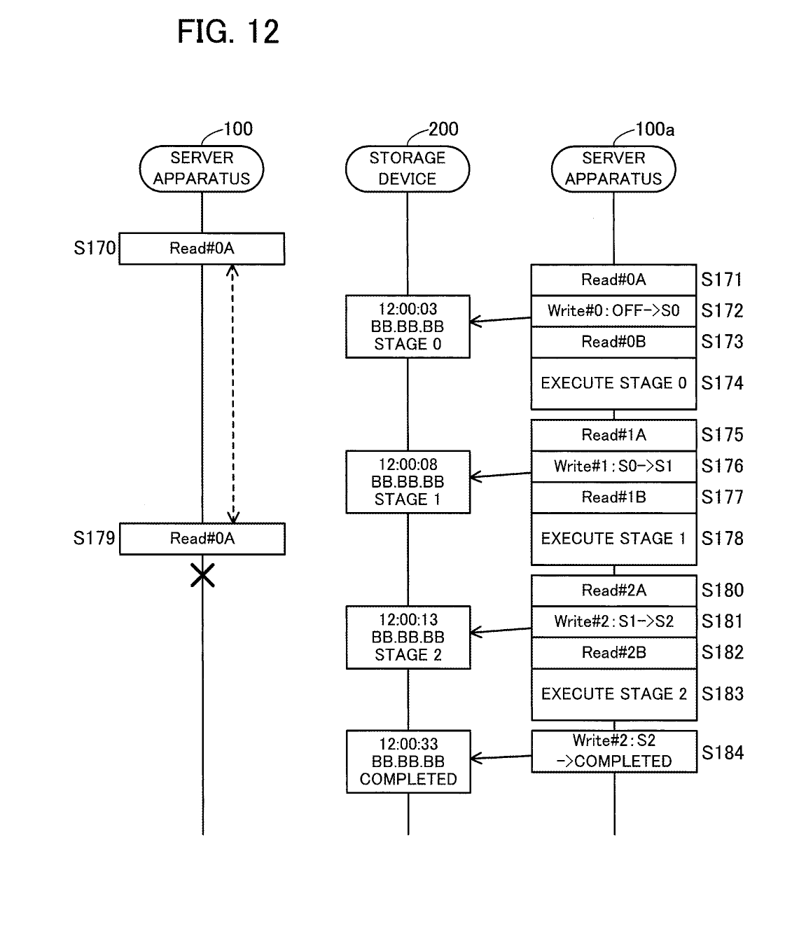

FIG. 12 illustrates the fourth example of launch processes by a plurality of server apparatuses. In the fourth example, the server apparatus 100 reads the launch control information 211 and then after a large delay updates the launch control information 211, and the server apparatus 100a interrupts during the delay.

The server apparatus 100 starts a database launch process to execute Read #0A (S170). Following the server apparatus 100, the server apparatus 100a also starts a database launch process to execute Read #0A (S171). An exclusive lock is not used in the access to the launch control information 211, and therefore both of the server apparatus 100 and the server apparatus 100a recognize that the stage information is “OFF”.

Since the stage information is “OFF”, the server apparatus 100a executes Write #0 (S172). Here, the time stamp is rewritten to “12:00:03”, and the MAC address is rewritten to “BB.BB.BB”, and the stage information is rewritten to “stage 0”. The server apparatus 100a executes Read #0B (S173) and starts stage 0 (S174).

After stage 0 ends, the server apparatus 100a executes Read #1A (S175). After confirming that the MAC address is of the server apparatus 100a, the server apparatus 100a executes Write #1 (S176). Here, the time stamp is rewritten to “12:00:08”, and the MAC address is rewritten to “BB.BB.BB”, and the stage information is rewritten to “stage 1”. Then, the server apparatus 100a executes Read #1B (S177) and starts stage 1 (S178).

When trying to execute Write #0, the server apparatus 100 detects that a certain amount of time (for example, approximately several seconds to 10 seconds) has passed since the end of Read #0A. Thus, considering the possibility that the server apparatus 100a has interrupted, the server apparatus 100 re-executes Read #0A (S179). Since the MAC address is not of the server apparatus 100, and the stage information is updated to “stage 1”, the server apparatus 100 does not execute Write #0. The server apparatus 100 re-executes Read #0A to confirm that the time stamp is updated, and thereafter cancels stages 0, 1, and 2 to start up in the maintenance mode.

After stage 1 ends, the server apparatus 100a executes Read #2A (S180). After confirming that the MAC address is of the server apparatus 100a, the server apparatus 100a executes Write #2 (S181). Here, the time stamp is rewritten to “12:00:13”, and the MAC address is rewritten to “BB.BB.BB”, and the stage information is rewritten to “stage 2”. The server apparatus 100a executes Read #2B (S182) and starts stage 2 (S183). After stage 2 ends, the server apparatus 100a updates the launch control information 211 (S184). Here, the time stamp is rewritten to “12:00:33”, and the MAC address is rewritten to “BB.BB.BB”, and the stage information is rewritten to “completed”.

As described above, when the delay time from reading to updating the launch control information 211 exceeds an expected value of execution time of stage 0 or stage 1, it is increasingly possible that another server apparatus updates the launch control information 211 first. Thus, when the delay time has exceeded the expected value of execution time of stage 0 or stage 1, the launch control information 211 is read again for the purpose of detecting an interrupt by the other server apparatus.

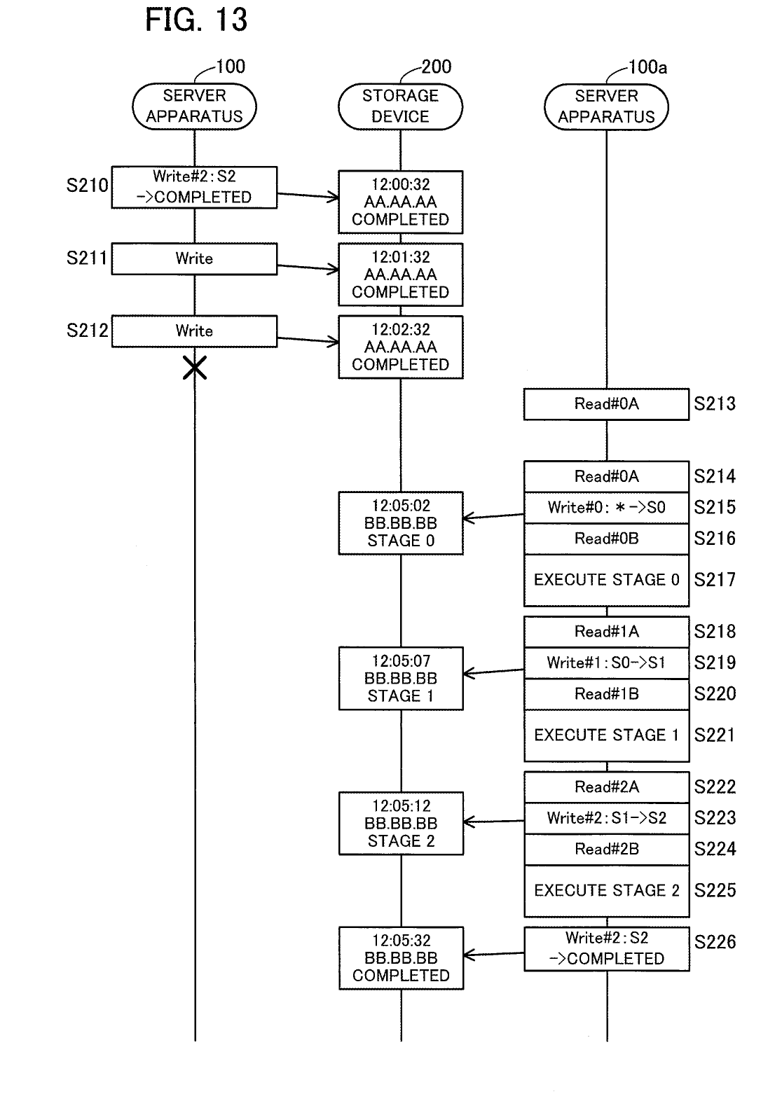

FIG. 13 illustrates the fifth example of launch processes by a plurality of server apparatuses. In the fifth example, the server apparatus 100 completes a database launch process, and thereafter abnormally halts without initializing the launch control information 211.

After stage 2 ends, the server apparatus 100 updates the launch control information 211 (S210). Here, the time stamp is rewritten to “12:00:32”, and the MAC address is rewritten to “AA.AA.AA”, and the stage information is rewritten to “completed”. The server apparatus 100 rewrites the time stamp on a regular basis (for example, at 1 minute intervals) (S211, S212). Thereafter, the server apparatus 100 abnormally halts without initializing the launch control information 211.

The server apparatus 100a starts a database launch process to execute Read #0A (S213). Since the MAC address is not of the server apparatus 100a, and the stage information is “completed”, the server apparatus 100a re-executes Read #0A (S214). After confirming that the time stamp is not updated, the server apparatus 100a determines that the server apparatus 100 has halted abnormally, and executes Write #0 (S215). Here, the time stamp is rewritten to “12:05:02”, and the MAC address is rewritten to “BB.BB.BB”, and the stage information is rewritten to “stage 0”. The server apparatus 100a executes Read #0B (S216) and starts stage 0 (S217).

After stage 0 ends, the server apparatus 100a executes Read #1A (S218). After confirming that the MAC address is of the server apparatus 100a, the server apparatus 100a executes Write #1 (S219). Here, the time stamp is rewritten to “12:05:07”, and the MAC address is rewritten to “BB.BB.BB”, and the stage information is rewritten to “stage 1”. The server apparatus 100a executes Read #1B (S220) and starts stage 1 (S221).

After stage 1 ends, the server apparatus 100a executes Read #2A (S222). After confirming that the MAC address is of the server apparatus 100a, the server apparatus 100a executes Write #2 (S223). Here, the time stamp is rewritten to “12:05:12”, and the MAC address is rewritten to “BB.BB.BB”, and the stage information is rewritten to “stage 2”. The server apparatus 100a executes Read #2B (S224) and starts stage 2 (S225). After stage 2 ends, the server apparatus 100a updates the launch control information 211 (S226). Here, the time stamp is rewritten to “12:05:32”, and the MAC address is rewritten to “BB.BB.BB”, and the stage information is rewritten to “completed”.

As described above, even when the server apparatus 100 abnormally halts without initializing the launch control information 211, the server apparatus 100a detects the abnormal halt from the fact that the time stamp is not updated. Thereby, the server apparatus 100a can start the operation of the database.

According to the information processing system of the second embodiment, the launch control information 211 is stored in the common storage device 200 connected to the server apparatuses 100 and 100a, and the database launch process is executed with reference to the launch control information 211. Thereby, without direct communication between the server apparatus 100 and the server apparatus 100a, the database is prevented from being launched simultaneously. For example, even if the network 30 is temporarily shut down, the database is prevented from being launched simultaneously. Thereby, even when the cluster management software temporarily halts, the data stored in the storage device 200 is prevented from being destroyed by mistake.

Also, before starting each of stages 0, 1, and 2, the MAC address and the stage information, which have been written into the launch control information 211, are referred. Thereby, the progress of the launch process by the other server apparatus becomes less likely to be overlooked, without using an exclusive lock in the access to the launch control information 211. Also, even when both of the server apparatuses 100 and 100a start a launch process, the launch process in a more advanced stage is prioritized, while the other launch process is halted. Thereby, the database is launched promptly.

Also, when the delay time from referring to the launch control information 211 to updating the launch control information 211 exceeds an execution time for one stage, the launch control information 211 is referred again and whether or not to continue the launch process is determined. Thereby, an interruption of the other server apparatus for the purpose of updating the launch control information 211 is detected. Also, the launch control information 211 is referred again after updating the launch control information 211 and before starting the next stage. Thereby, overwriting the launch control information 211 by the other server apparatus is detected immediately after the launch control information 211 is updated.

Note that, as described above, the information processing of the first embodiment is achieved by causing the launch control apparatuses 10 and 10a to execute a program. The information processing of the second embodiment is achieved by causing the server apparatuses 100 and 100a to execute a program.

The program is stored in a computer-readable storage medium (for example, the storage medium 43). The storage medium is, for example, a magnetic disk, an optical disc, a magneto-optical disk, and a semiconductor memory. The magnetic disk includes an FD and an HDD. The optical disc includes a CD, a CD-R(Recordable)/RW(ReWritable), a DVD, and a DVD-R/RW. A program may be stored in a portable storage medium for the purpose of distribution. In that case, the program may be executed after copied (installed) from the portable storage medium to another storage medium, such as an HDD (for example, the HDD 103).

In one aspect, database launch processes are prevented from being executed simultaneously.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to perform a process comprising:
storing identification information indicating the computer and progress information indicating a progress status of a database launch process including a plurality of processes that are to be executed in a predetermined order in the computer, in a predetermined storage region of a memory device, in response to execution of each of the plurality of processes, when executing the database launch process using the memory device; and
determining whether or not to continue the launch process on the basis of statuses of the stored identification information and progress information, with reference to the predetermined storage region, in response to completion of each of the plurality of processes.

2. The non-transitory computer-readable storage medium storing the computer program according to claim 1, wherein
the determining includes determining whether or not to continue the launch process, on the basis of whether or not other identification information indicating another computer is stored in the predetermined storage region, and whether or not other progress information indicating one of the processes that has not been executed in the computer is stored in the predetermined storage region.

3. The non-transitory computer-readable storage medium storing the computer program according to claim 2, wherein
the determining includes determining whether or not to continue the launch process, on the basis of whether or not time information stored in the predetermined storage region is updated, when the other identification information and the other progress information are stored in the predetermined storage region.

4. The non-transitory computer-readable storage medium storing the computer program according to claim 1, wherein
the process further includes
re-determining whether or not to continue the launch process, when detecting that a predetermined time or more has passed, after determining to continue the launch process, and before storing in the predetermined storage region the progress information corresponding to one of the processes that is to be executed next in the computer.

5. The non-transitory computer-readable storage medium storing the computer program according to claim 1, wherein
the determining includes determining whether or not to continue the launch process on the basis of the status of the stored identification information, with reference to the predetermined storage region, after storing the identification information and the progress information in the predetermined storage region, and before starting one of the processes that corresponds to the progress information.

6. The non-transitory computer-readable storage medium storing the computer program according to claim 1, wherein
the memory device includes a plurality of other storage regions that are different from the predetermined storage region, and
each of the processes includes accessing one of the other storage regions that corresponds to the process.

7. A launch control method comprising:
storing, by a processor of a computer, identification information indicating the computer and progress information indicating a progress status of a database launch process including a plurality of processes that are to be executed in a predetermined order in the computer, in a predetermined storage region of a memory device, in response to execution of each of the plurality of processes, when executing the database launch process using the memory device; and
determining, by the processor, whether or not to continue the launch process on the basis of statuses of the stored identification information and progress information, with reference to the predetermined storage region, in response to completion of each of the plurality of processes.

8. A launch control apparatus comprising:
an interface configured to access a memory device used as a database;
a processor configured to perform a process including:
storing identification information indicating the launch control apparatus and progress information indicating a progress status of a database launch process including a plurality of processes that are to be executed in a predetermined order in the launch control apparatus, in a predetermined storage region of the memory device, in response to execution of each of the plurality of processes, when executing the database launch process, and
determining whether or not to continue the launch process on the basis of statuses of the stored identification information and progress information, with reference to the predetermined storage region, in response to completion of each of the plurality of processes.
